(19) United States
(12) Patent Application Publication
(10) Pub. No.: US 2003/0076418 A1
(43) Pub. Date: Apr. 24, 2003

(54) Testing apparatus and encoder

(75) Inventor: Takatoshi Nishio, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/216,752

(22) Filed: Aug. 13, 2002

(30) Foreign Application Priority Data
Oct. 18, 2001 (JP) 2001-320401

(51) Int. Cl. H04N 17/02

(52) U.S. Cl. 348/180; 348/192

(57) ABSTRACT

The testing apparatus of the invention includes an MPEG encoder, a memory, an MPEG decoder, a comparator and a determiner. The MPEG encoder, which stores in advance grammar rules of MPEG Audio (encoding/decoding rules) to enable MPEG Audio encoding, outputs a bit string (stream) conforming to the MPEG Audio grammar rules in frame units. When a parameter (variable) or parameters of MPEG Audio are designated, the MPEG encoder prepares frames so that all possible values to be taken by each designated parameter are covered under the MPEG Audio encoding conditions, and continues outputting the frames until this is done for all of the designated parameters.

### BACKGROUND OF THE INVENTION

The present invention relates to a testing apparatus and an encoder, and more particularly, to a testing apparatus for testing a decoder for performing decoding in conformity with predetermined encoding/decoding rules and an encoder used in the testing apparatus.

In a process of testing of MPEG decoders to be mounted in DVD players and the like, various data streams are input into the decoders to check whether or not no problem arises in the decoders. A testing apparatus performs this check in the following manner. An input image signal is converted into an MPEG stream by an MPEG encoder and stored in a memory. The MPEG stream stored in the memory is sequentially read and fed into an MPEG decoder to be tested. The MPEG decoder to be tested decodes the MPEG stream read from the memory. The testing apparatus displays an image signal decoded by the MPEG decoder to be tested on a monitor. The image signal displayed on the monitor is checked to determine whether or not the MPEG decoder to be tested has no problem. Various input image signals are fed into the testing apparatus to make sure of adaptability of the MPEG decoder to be tested to various streams.

Variables of an MPEG stream fed into the MPEG decoder to be tested depend on an input image signal into the MPEG encoder of the testing apparatus. Therefore, it is not possible to set values freely for variables of an MPEG stream to be fed into the MPEG decoder to be tested even when a large number of input image signals are fed into the testing apparatus. In other words, all possible values for respective variables are not tested. This indicates that if a value for a variable that has not been tested occurs in actual use, the decoder may cause a problem.

### SUMMARY OF THE INVENTION

An object of the present invention is providing a testing apparatus capable of verifying that a decoder to be tested operates reliably.

The testing apparatus of the present invention is a testing apparatus for testing a decoder for performing decoding in conformity with predetermined encoding/decoding rules, including an encoder, a decoder and a comparison determiner. The encoder generates a frame as a bit string including a plurality of variables in conformity with the encoding/decoding rules and outputs the generated frame. The decoder decodes the frame from the encoder. Proper decoding in conformity with the encoding/decoding rules of the decoder has already been verified. The comparison determiner compares results of decoding of the frame from the encoder by the decoder with results of decoding of the frame from the encoder by a decoder to be tested, and determines whether or not the decoder to be tested is acceptable. The encoder generates a plurality of frames including different values set for a predetermined variable among the plurality of variables, and outputs the frames.

In the encoder, preferably, the different values for the predetermined variable include desired values among all possible values to be taken by the predetermined variable in conformity with the encoding/decoding rules.

In the encoder, preferably, the different values for the predetermined variable include all possible values to be taken by the predetermined variable.

According to the invention, the testing apparatus includes the encoder capable of adjusting the value for a variable independent of an input signal. It is therefore possible to freely change a predetermined variable independent of the input signal. In addition, the testing apparatus can set values to be taken by a variable desired to be examined during the testing of the decoder to be tested. Therefore, reliable testing is possible.

If the stream from the encoder covers all possible values to be taken by all the variables, it is possible to verify that the decoder to be tested operates reliably without fail. Even in the case that the stream covers only part of the possible values, it is possible to quantitatively determine the range within which the verification has been made.

In the encoder, preferably, a desired variable among the plurality of variables included in the frame to be output is set to take a value violating the encoding/decoding rules.

In the testing apparatus described above, it is possible to check how the decoder to be tested behaves for a stream including the variable violating the encoding/decoding rules.

The encoder of the present invention is an encoder for generating a frame as a bit string including a plurality of variables in conformity with the encoding/decoding rules and outputting the generated frame. The encoder generates a plurality of frames including different values set for a predetermined variable among the plurality of variables, and outputs the frames.

Preferably, the different values for the predetermined variable include desired values among all possible values to be taken by the predetermined variable in conformity with the encoding/decoding rules.

Preferably, the different values for the predetermined variable include all possible values to be taken by the predetermined variable.

Preferably, a desired variable among the plurality of variables included in the frame to be output is set to take a value violating the encoding/decoding rules.

### BRIEF DESCRIPTION OF THE DRAWINGS

FIG. 1 is a block diagram of a testing apparatus of an embodiment of the present invention.

FIG. 2A is a view of an MPEG Audio frame structure, FIG. 2B is a view of parameters included in a header of the frame, and FIG. 2C is a view showing the details and the number of bits of the parameters in the header.

FIG. 3 is a flowchart of processing by an MPEG encoder in FIG. 1.

### DESCRIPTION OF THE PREFERRED EMBODIMENTS

Hereinafter, a preferred embodiment of the present invention will be described with reference to the accompanying drawings.

<Entire Configuration of Testing Apparatus>

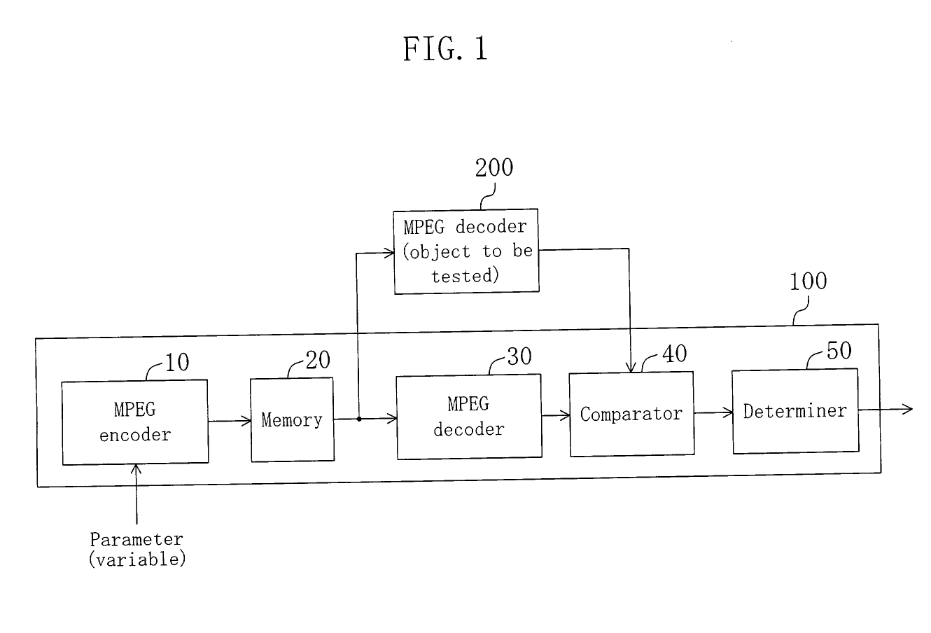

FIG. 1 illustrates the entire configuration of the testing apparatus of an embodiment of the present invention. The testing apparatus shown in FIG. 1, denoted by 100, is an apparatus for testing an MPEG decoder 200. The MPEG decoder 200 as the object to be tested is a decoder for decoding data encoded in conformity with MPEG Audio (encoding/decoding rules).

The testing apparatus 100 includes an MPEG encoder 10, a memory 20, an MPEG decoder 30, a comparator 40 and a determiner 50.

The MPEG encoder 10 stores in advance grammar rules of MPEG Audio (encoding/decoding rules) to enable MPEG Audio encoding. The MPEG encoder 10 outputs a bit string (stream) conforming to the MPEG Audio grammar rules in units of frames. When a parameter (variable) or parameters of MPEG Audio are designated, the MPEG encoder 10 prepares frames so that all possible values to be taken by each designated parameter are covered under the MPEG Audio encoding conditions, and continues outputting the frames until this is done for all of the designated parameters. In addition, the MPEG encoder 10 intentionally prepares a frame violating the MPEG Audio encoding rule for a specific parameter designated and outputs the frame.

The data string output from the MPEG encoder 10 is stored in the memory 20. Frames read from the memory 20 are input into both the MPEG decoder 30 and the MPEG decoder 200 to be tested.

The MPEG decoder 30 is a decoder of which proper operation in conformity with MPEG Audio has been verified. The MPEG decoder 30 decodes the stream read from the memory 20 in conformity with MPEG Audio and outputs the decoded results to the comparator 40.

The comparator 40 compares the decoded results output from the MPEG decoder 30 and decoded results output from the MPEG decoder 200 with each other, and outputs “0” to the determiner 50 when they match with each other and “1” when they do not match with each other.

The determiner 50 outputs an inactive control signal externally when the output of the comparator 40 is “0”, and outputs an active control signal externally when the output of the comparator 40 is “1”. In response to the output of the active control signal from the determiner 50, a buzzer (not shown) placed externally generates an audible alarm.

<Processing by MPEG Encoder>

The processing by the MPEG encoder 10 shown in FIG. 1 will be described in detail.

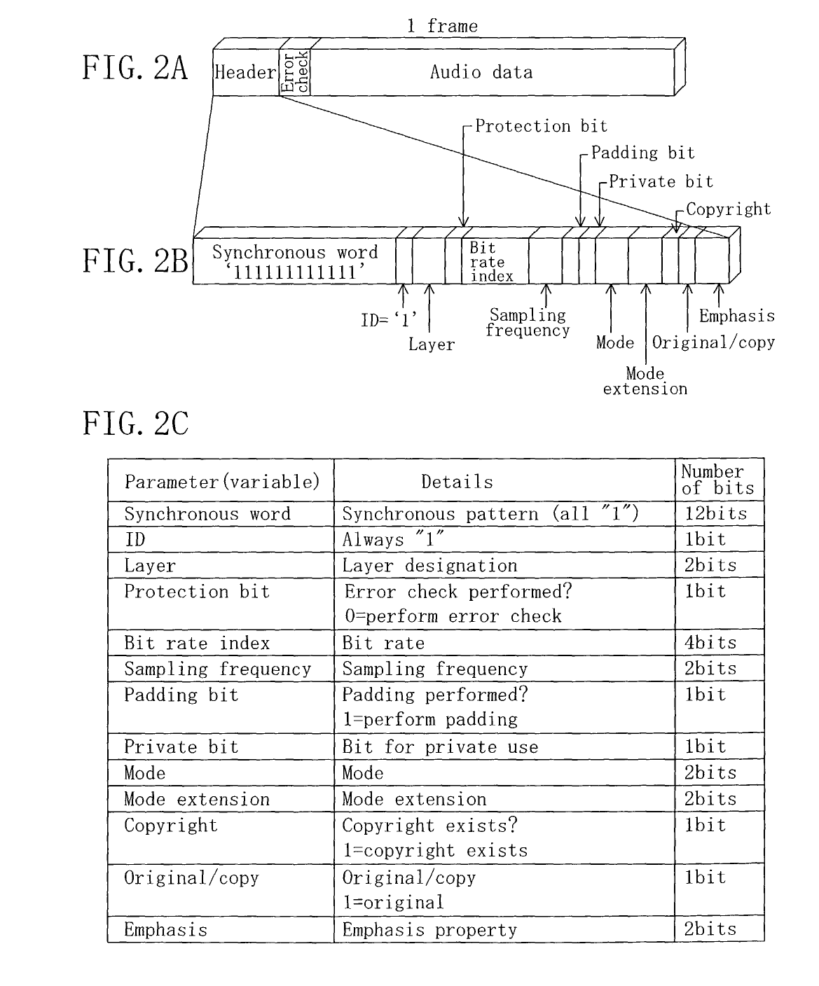

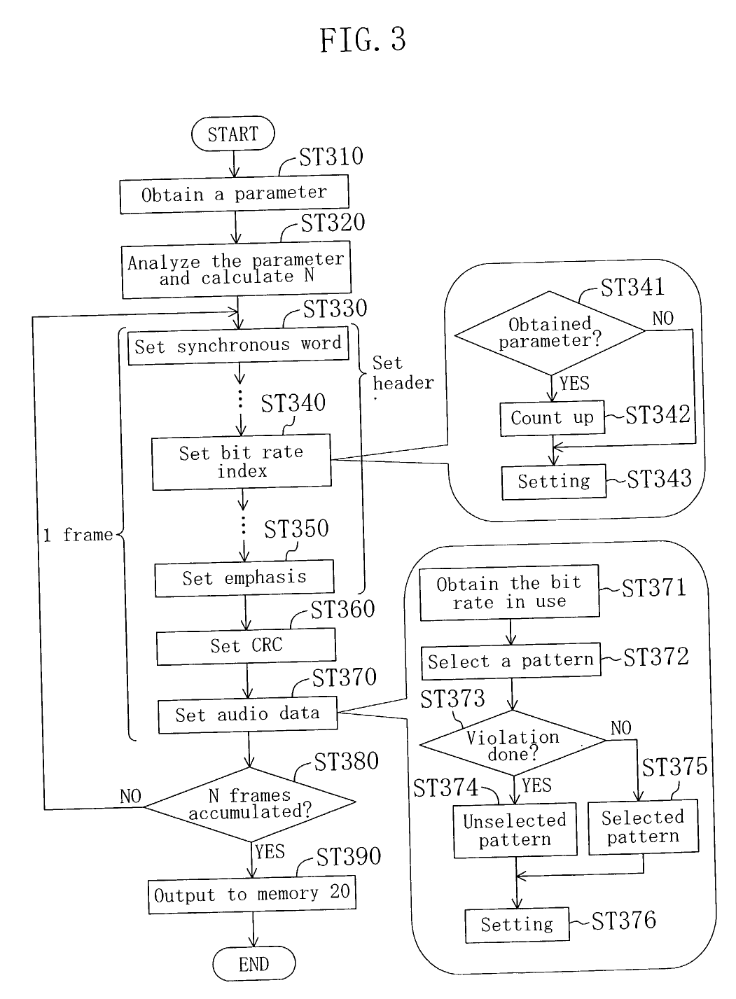

The MPEG encoder 10 generates a bit string having a frame structure as shown in FIG. 2A and outputs the bit string to the memory 20. Referring to FIG. 2A, one frame of MPEG Audio includes a header, an error check (CRC) and audio data. Each of the header, the CRC and the audio data includes one parameter or a plurality of parameters. For example, the header includes parameters as shown in FIG. 2B. The details and the numbers of bits of the respective parameters included in the header are as shown in FIG. 2C. The MPEG encoder 10 generates a bit string according to the flowchart shown in FIG. 3. Hereinafter, the processing by the MPEG encoder 10 will be described with reference to FIG. 3.

First, one parameter (variable) or a plurality of parameters are designated for the MPEG encoder 10 (step ST310). Assume in this example that a parameter “bit rate index” is designated.

The designated parameter is analyzed to calculate the number N of possible values that the parameter can take (step ST320). The parameter “bit rate index”, having four bits allocated as shown in FIG. 2C, actually takes only 14 different values. Therefore, in this example, 14 is obtained as the number N.

Thereafter, the header is prepared (steps ST330 to ST350). The header includes a plurality of parameters, from “synchronous word” to “emphasis” as shown in FIGS. 2B and 2C. Predetermined values are set for the respective parameters. In FIG. 3, only the steps of setting “synchronous word” (step ST330), “bit rate index” (step ST340) and “emphasis” (step ST350) are shown, omitting the steps of setting the other parameters. The processing in the parameter setting step will be described taking the step of setting “bit rate index” (ST340) as an example. First, whether or not the parameter in question is the parameter designated in step ST310 is determined (ST341). Since the “bit rate index” is the designated parameter, the number of preset values for this parameter is counted up (step ST342), and the relevant preset value is set for this parameter (step ST343). In the case of an undesignated parameter, a preset value is just set for the parameter. In this way, predetermined values are set for the respective parameters included in the header.

A value is then set for the CRC (error check) (step ST360), in substantially the same manner as that described for the setting of the header.

Audio data is then set (step ST370). First, the bit rate is determined based on the “bit rate index” set in step ST340 (step ST371), and a pattern according to the determined bit rate is selected (step ST372). Thereafter, whether or not audio data to be set should be made to violate MPEG Audio is determined (step ST373). Since no instruction to violate MPEG Audio has been made in this example, the pattern selected in step ST372 is set as the audio data (steps ST375 and ST376). In the case that an instruction to violate MPEG Audio has been made, a pattern different from the pattern selected in step ST372 is set as the audio data (steps ST374 and ST376).

Thus, a bit string of one frame of MPEG Audio is generated. The generated data is stored in an internal memory (not shown).

Thereafter, whether or not data corresponding to N frames has been accumulated in the internal memory is determined (step ST380). If not yet accumulated, the process returns to step ST330. If accumulated, the data corresponding to N frames is output to the external memory 20 (step ST390).

By the processing described above, MPEG Audio data covering all possible values to be taken by the designated parameter (“bit rate index” in this example) is obtained.

The data obtained by the above processing conforms to MPEG Audio (encoding/decoding rules). The MPEG encoder 10 can also prepare a frame including a parameter violating MPEG Audio. For example, a frame including audio data violating MPEG Audio can be prepared by setting a pattern different from the pattern selected in step ST372 as the audio data (steps ST374 and ST376). A violating frame can also be prepared by skipping a specific parameter setting step (for example, the step of setting “emphasis” (ST350)). Alternatively, the positions of some parameter setting steps (for example, the step of setting “emphasis” (ST350) and the step of setting CRC (ST360)) in the process flow may be interchanged with each other. Otherwise, an actually nonexistent pattern may be used. For example, since the number of actually used patterns of “bit rate index” is 14 as described above, N=15 may be set in step ST320, to enable setting of an actually nonexistent pattern for this parameter.

In the above description, the parameter “bit rate index” was designated in step ST310. Alternatively, any of the other parameters may be designated.

In the above description, only one parameter was designated in step ST310. Alternatively, a plurality of parameters may be designated.

In the above description, all possible values to be taken by the designated parameter were covered. Alternatively, only part of such values may be covered, to enable setting of values of a desired parameter within a desired range.

In addition, all the parameters may be made to conform to or violate MPEG Audio.

<Operation of Testing Apparatus>

A flow of testing performed by the testing apparatus shown in FIG. 1 will be described.

A bit string (stream) output from the MPEG encoder 10 is stored in the memory 20. A data string read from the memory 20 is input into both the MPEG decoder 30 and the MPEG decoder 200 to be tested. The MPEG decoder 30 and the MPEG decoder 200 decode the stream read from the memory 20. The comparator 40 compares the decoded results output from the MPEG decoder 200 to be tested with the decoded results output from the MPEG decoder 30. When the output of the comparator 40 indicates a mismatch, the buzzer (not shown) generates an audible alarm.

The MPEG encoder 10 can prepare a stream including a parameter violating MPEG Audio as described above. Therefore, it is possible to check how the MPEG decoder 200 to be tested behaves for such a stream including a parameter violating MPEG Audio.

<Effect>

According to the testing apparatus of the present invention, including the MPEG encoder 10, MPEG Audio data covering all possible values to be taken by all the parameters can be fed into the MPEG decoder 200 to be tested. In this case, it is possible to verify that the MPEG decoder 200 to be tested operates reliably without fail. Even in the case that only part of all possible values taken by the parameters is covered, it is possible to quantitatively determine the range within which the verification has been made.

<Alterations>

In the above embodiment, MPEG Audio was adopted as the encoding/decoding rules. The present invention is also applicable to cases of adopting other encoding/decoding rules, such as MPEG1, 2, 4 (video, audio, system), DTS, AC-3, AAC, DVD-Audio, CD-DA and encryption (C6, DTCP, DES).

In the above embodiment, the stream output from the MPEG encoder 10 was stored temporarily in the memory 20 before being fed into the MPEG decoders 30 and 200. Alternatively, the stream may be directly fed into the MPEG decoders.

The determination result from the determiner 50 was announced by the buzzer. Alternatively, a lamp or a monitor screen may be used.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A testing apparatus for testing a decoder for performing decoding in conformity with predetermined encoding/decoding rules, comprising:
an encoder for generating a frame as a bit string including a plurality of variables in conformity with the encoding/decoding rules and outputting the generated frame;
a decoder for decoding the frame from the encoder, proper decoding in conformity with the encoding/decoding rules of the decoder having been verified; and
a comparison determiner for comparing results of decoding of the frame from the encoder by the decoder with results of decoding of the frame from the encoder by a decoder to be tested, and determining whether or not the decoder to be tested is acceptable,
wherein the encoder generates a plurality of frames including different values set for a predetermined variable among the plurality of variables, and outputs the frames.

2. The apparatus of claim 1, wherein in the encoder, the different values for the predetermined variable include desired values among all possible values to be taken by the predetermined variable in conformity with the encoding/decoding rules.

3. The apparatus of claim 2, wherein in the encoder, the different values for the predetermined variable include all possible values to be taken by the predetermined variable.

4. The apparatus of claim 1, wherein in the encoder, a desired variable among the plurality of variables included in the frame to be output is set to take a value violating the encoding/decoding rules.

5. An encoder for generating a frame as a bit string including a plurality of variables in conformity with the encoding/decoding rules and outputting the generated frame, wherein the encoder generates a plurality of frames including different values set for a predetermined variable among the plurality of variables, and outputs the frames.

6. The encoder of claim 5, wherein the different values for the predetermined variable include desired values among all possible values to be taken by the predetermined variable in conformity with the encoding/decoding rules.

7. The encoder of claim 6, wherein the different values for the predetermined variable include all possible values to be taken by the predetermined variable.

8. The encoder of claim 5, wherein a desired variable among the plurality of variables included in the frame to be output is set to take a value violating the encoding/decoding rules.
